(19) United States
(12) Patent Application Publication
(10) Pub. No.: US 2013/0166853 A1
(43) Pub. Date: Jun. 27, 2013

(54) SEMICONDUCTOR MEMORY DEVICE AND OPERATING METHOD THEREOF

(71) Applicants: Hyun CHUNG, Seoul (KR); Jin Su PARK, Icheon-si (KR)

(72) Inventors: Hyun CHUNG, Seoul (KR); Jin Su PARK, Icheon-si (KR)

(73) Assignee: SK HYNIX INC., Icheon-si (KR)

(21) Appl. No.: 13/614,238

(22) Filed: Sep. 13, 2012

(30) Foreign Application Priority Data
Dec. 22, 2011 (KR) 10-2011-0140199

(51) Int. Cl. G06F 12/00

(52) U.S. Cl. 711/154; 711/E12.001

(57) ABSTRACT

In a semiconductor memory device, when input data is latched to page buffers, first, the data is sequentially latched to even page buffers and subsequently latched to odd page buffers, and then the data is programmed to each memory cell. Thus, when data having a size of a half page or smaller is read, a read operation is performed only on even memory cells or odd memory cells, thus reducing a time required for the read operation.

### CROSS-REFERENCE TO RELATED APPLICATION

Priority is claimed to Korean patent application number 10-2011-0140199 filed on Dec. 22, 2011, the entire disclosure of which is incorporated herein by reference in its entirety.

### BACKGROUND

The present invention relates generally to a semiconductor memory device and an operating method thereof, and, more particularly, to a semiconductor memory device in which the time required for a read operation is shortened, and an operating method thereof.

In a semiconductor memory device, particularly a flash memory device, reading data from a memory cell is performed by page. ‘Read time’ refers to the time required for a read operation. In particular, ‘read time’ refers to the time required for reading data stored in all of the flash memory cells of one page, and latching the data to a page buffer in order to output it to an input/output circuit. However, since the read operation is performed by page, even though a user may require only data having a size smaller than one page, the read operation is generally performed on every memory cell of the page, increasing the read time.

As the degree of integration of a flash memory increases, the size of a page also gradually increases, so the operation of reading data having a size of a half page or smaller is performed more frequently. Accordingly, a need arises for a semiconductor memory device having a reduced read time when reading data having a size of a half page or smaller.

### SUMMARY

Example embodiments relate to a semiconductor memory device and an operating method thereof capable of shortening a time required for a read operation by performing a read operation only on memory cells of a half page in reading data having the size of a half page or smaller.

A semiconductor memory device in accordance with an embodiment of the present invention includes: a memory block including memory cells electrically connected to bit lines; a page buffer group including page buffers disposed to correspond to the bit lines in a one-to-one manner and divided into even page buffers and odd page buffers; and a control circuit configured to control the page group to sequentially store data in even memory cells among the memory cells through the even page buffers, and subsequently store data in odd memory cells through the odd page buffers, in response to a write command, and sequentially output data read from the even memory cells through the even page buffers in response to a half page read command.

A semiconductor memory device in accordance with another embodiment of the present invention includes: a memory block including memory cells electrically connected to bit lines; a page buffer group including page buffers disposed to correspond to the bit lines in a one-to-one manner and divided into even page buffers and odd page buffers; a column selecting circuit configured to select either the even page buffers or the odd page buffers according to column addresses, to perform a data input/output operation on even memory cells among the memory cells through the even page buffers, and perform a data input/output operation on odd memory cells through the odd page buffers; and a column address control circuit configured to output the column addresses, to allow the column selecting circuit to sequentially select the even page buffers and subsequently select the odd page buffers, during a data input operation in response to a write command, and output the column addresses, to allow the column selecting circuit to sequentially select the even page buffers during a data output operation, in response to a half page read command.

A method for operating a semiconductor memory device in which page buffers are disposed to correspond to bit lines in a one-to-one manner, in accordance with yet another embodiment of the present invention, includes: sequentially storing data input from an input/output circuit in even memory cells and subsequently storing the data in odd memory cells according to a write command and column addresses; and outputting data read from the even memory cells to the input/output circuit according to a half page read command and column addresses.

A method for operating a semiconductor memory device in which page buffers are disposed to correspond to bit lines in a one-to-one manner, in accordance with still another embodiment of the present invention, includes: sequentially storing data input from an input/output circuit in even memory buffers according to a write command and column addresses; programming the data in even memory cells; reading the data programmed in the even memory cells to the even page buffers; and sequentially outputting the data stored in the even page buffers to the input/output circuit according to a half page read command and column addresses.

### BRIEF DESCRIPTION OF THE DRAWINGS

FIG. 1 is a block diagram illustrating a semiconductor memory device in accordance with an embodiment of the present invention.

FIG. 2 is a circuit diagram illustrating a memory block of FIG. 1.

FIG. 3 is a circuit diagram illustrating a page buffer group of FIG. 1.

FIG. 4 is a circuit diagram illustrating a column address counter of FIG. 1.

FIG. 5 is a flow chart depicting an operating method of a semiconductor memory device in accordance with an embodiment of the present invention.

FIGS. 6A and 6B are timing diagrams associated with an operating method of a memory device.

FIGS. 7A and 7B represent relationships between column address and page buffer for a semiconductor memory device in accordance with an embodiment of the present invention.

### DETAILED DESCRIPTION

Hereinafter, embodiments in accordance with the present invention will be explained in more detail with reference to the accompanying drawings. Although embodiments in accordance with the present invention are described with reference to a number of examples thereof, it should be understood that numerous variations and modifications can be devised by those skilled in the art that will fall within the spirit and scope of the invention.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

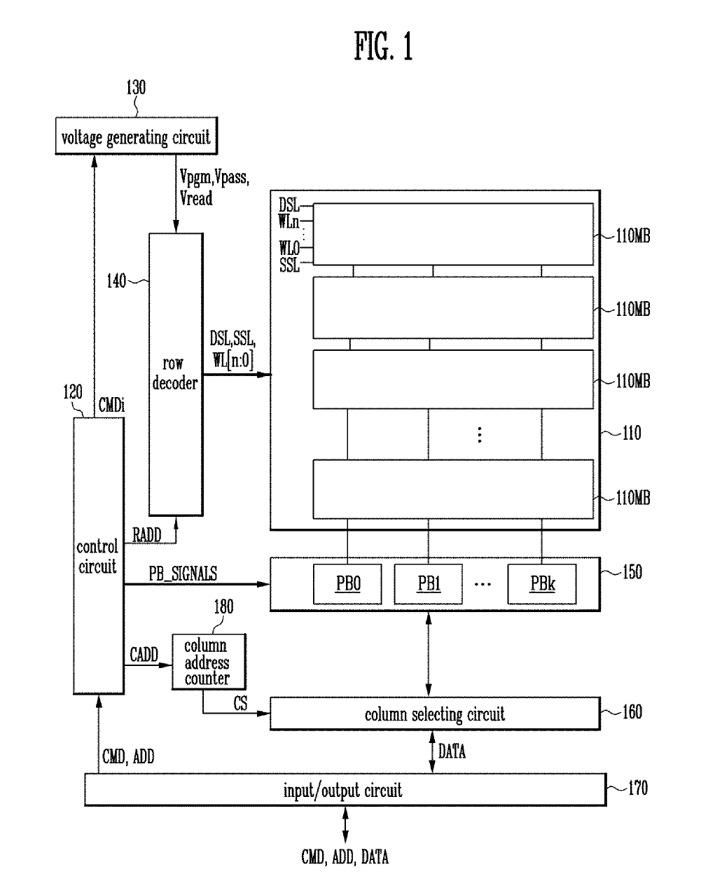

A semiconductor memory device in accordance with an embodiment of the present invention is illustrated in block diagram form in FIG. 1. The semiconductor memory device includes a memory array 110, with a plurality of memory blocks 110MB, operating circuits 130, 140, 150, 160, 170, and 180 configured to perform a program operation, a read operation, and a test operation on memory cells included within a selected page of the memory cell blocks 110MB, and a control circuit 120 configured to control the operating circuits 130, 140, 150, 160, 170, and 180. In the case of a NAND flash memory device, operating circuits include voltage supply circuits 130 and 140, a page buffer group 150, a column selecting circuit 160, an input/output circuit 170, and a column address counter 180.

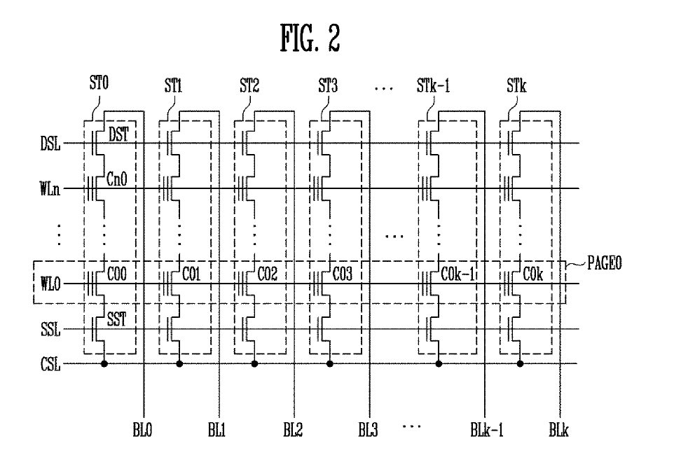

The memory array 110 includes a plurality of memory blocks 110MB. As shown in FIG. 2, each of the memory blocks 110MB includes a plurality of strings ST0˜STk connected between bit lines BL0˜BLk and a common source line CSL. Specifically, the strings ST0˜STk are connected to corresponding bit lines BL0˜BLk, respectively, and commonly connected to the common source line CSL. Each string ST0 includes a source selection transistor SST having a source connected to the common source line CSL, a plurality of memory cells C00˜Cn, and a drain selection transistor DST having a drain connected to the bit line BL0. The memory cells C00˜Cn0 are connected in series between the selection transistors SST and DST. A gate of the source selection transistor SST is connected to the source selection line SSL, gates of the memory cells C00˜Cn0 are connected to word lines WL0˜WLn, and a gate of the drain selection transistor DST is connected to a drain select line DSL.

In the NAND flash memory device, memory cells included in a memory block may be divided into a physical page unit and a logical page unit. For example, the memory cells C00˜C0k connected to one word line (e.g., WL0) may constitute a single physical page PAGE0. Also, even numbered memory cells connected to one word line (e.g., WL0) may constitute one even physical page, and odd numbered memory cells connected to one word line may constitute one odd physical page. The page (or an even page and an odd page) is a basic unit of a program operation or read operation. In an embodiment of the present invention, a case in which memory cells connected to one word line constitute one physical page will be described.

Referring back to FIGS. 1 and 2, in response to a control command CMD input through the input/output circuit 170 from an external device, the control circuit 120 outputs an internal command signal CMDi for performing a program operation or a read operation and outputs PB control signals PB_SIGNALS for controlling the page buffers PB0˜PBk included in the page buffer group 150 according to the type of operation. The operation of controlling the page buffer group 150 by the control circuit 120 will be described subsequently. Also, the control circuit 120 outputs a row address signal RADD and a column address signal CADD in response to an address signal ADD input through the input/output circuit 170.

In response to the internal command signal CMDi from the control circuit 120, the voltage supply circuits 130 and 140 supply operating voltages (e.g., Vpgm, Vread, and Vpass) required for a program operation or read operation to local lines, including a drain selection line DSL, word lines WL0, . . . , WLn, and a source selection line SSL of a selected memory cell block. The voltage supply circuits include a voltage generating circuit and a row decoder 140.

In response to the internal command signal CMDi from the control circuit 120, the voltage generating circuit 130 outputs the operating voltage (e.g., Vpgm, Vread, and Vpass) required for a program operation or read operation to the global lines. For example, for a program operation, the voltage generating circuit 130 outputs the program voltage Vpgm to be applied to memory cells of a selected page, and the pass voltage Vpass to be applied to unselected memory cells, to the global lines. For a read operation, the voltage generating circuit 130 outputs the read voltage Vread to be applied to the memory cells of the selected page, and the pass voltage Vpass to be applied to the unselected memory cells, to the global lines.

In response to the row address signal RADD, the row decoder 140 connects the global lines and the local lines DSL, WL0˜WLn, and SSL, so that the operating voltage output to the global lines may be transferred to the local lines DSL, WL0˜WLn, SSL of the memory 110MB selected from the memory block 110. Accordingly, the program voltage Vpgm or the read voltage Vread is applied to the local word line (e.g., WL0) connected to the selected cell (e.g., C00) through a global word line from the voltage generating circuit 130. Also, the pass voltage Vpass is applied to the local word lines (e.g., WL1˜WLn) connected to the unselected cells C10˜Cn0 through global word lines from the voltage generating circuit 130. Accordingly, data may be stored in the selected cell C00 by the program voltage Vpgm or data stored in the selected cell C00 may be read by the read voltage Vread.

The page buffer group 150 includes a plurality of page buffers PB0˜PBk connected to the memory array 110 through bit lines BL0˜BLk. In response to the PB control signal PB_SIGNALS from the control circuit 120, the page buffers PB0˜PBk of the page buffer group 150 selectively precharge the bit lines BL0˜BLk according to data in order to store data to the memory cells C00˜C0k or sense a voltage of the bit lines BL0˜BLk to read data from the memory cells C00˜C0k.

For example, when program data (e.g., data ‘0’) to be stored in the memory cell C00 is input to the page buffer PB0, the page buffer PB0 applies a program permission voltage (e.g., a ground voltage) to the bit line BL0 of the memory cell C00 in which the program data is to be stored during a program operation. As a result, a threshold voltage of the memory cell C00 is raised by the program voltage Vpgm applied to the word line WL0 and the program permission voltage applied to the bit line BL0 during the program operation. When erase data (e.g., data ‘1’) to be stored in the memory cell C00 is input to the page buffer PB0, the page buffer PB0 applies a program inhibition voltage (e.g., a power supply voltage) to the bit line BL0 of the memory cell C00 in which the erase data is to be stored during the program operation. As a result, although the program voltage Vpgm is applied to the word line WL0 during the program operation, the threshold voltage of the memory cell C00 is not raised by the program inhibition voltage applied to the bit line BL0. Thus, since the threshold voltages are different, different data may be stored in the memory cell.

During a read operation, the page buffer group 150 precharges all the selected bit lines (e.g., BL0˜BLk). And, when read voltage Vread is applied to the selected word line WL0 from the voltage supply circuits 130 and 140, the bit lines of the memory cells in which the program data is stored are maintained in a precharged state, while the bit lines of the memory cells in which the erase data is stored are discharged. The page buffer group 150 senses a change in the voltage of the bit lines BL0˜BLk and latches data of the memory cells corresponding to the sensed results. A detailed description of the page buffer will be provided subsequently.

In response to the column address signal CADD output from the control circuit 120, the column address counter 180 outputs a column counter signal CS. In general, when a start column address is output from the control circuit 120, the column address counter 180 increases a column address by 1 each time to output it as the column counter signal CS. The column address counter 180 and the control circuit 120 may be integrated as a column address control circuit. In an embodiment of the present invention, the column address is increased by 2 each time to output the column counter signal CS, and this will be described hereinafter.

In response to the column address signal CS output from the column address counter 180, the column selecting circuit 160 selects page buffers PB0˜PBk included in the page buffer group 150. In particular, in response to the column counter signal CS, the column selecting circuit 160 sequentially delivers data to be stored in memory cells to the page buffers PB0˜PBk. Also, in response to the column counter signal CS, the column selecting circuit 160 sequentially selects the page buffers PB0˜PBk so that data from the memory cells latched to the page buffer may be output to an external device in accordance with a read operation.

In order to input data received from an external source to the page buffer group 150, so the data can be stored in memory cells during a program operation, the input/output circuit 170 delivers data to the column selecting circuit 160 under the control of the control circuit 120. When the column selecting circuit 160 delivers the data transferred from the input/output circuit 170 to the page buffers PB0˜PBk of the page buffer group 150, according to the foregoing scheme, the page buffers PB0˜PBk store the input data to an internal latch circuit. During a read operation, the input/output circuit 170 outputs the data delivered through the column selecting circuit 160 from the page buffers PB0˜PBk of the page buffer group 150.

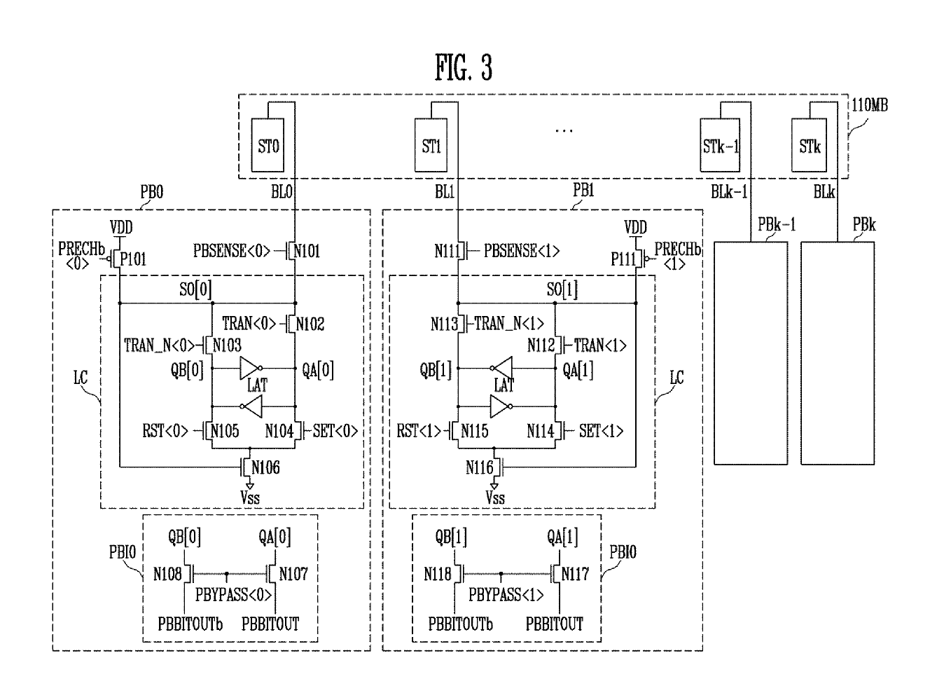

FIG. 3 is a circuit diagram illustrating the page buffer group of FIG. 1. Referring to FIG. 3, each of the page buffers PB0˜PBk is operated under the control of the control circuit (120 in FIG. 1), and signals PRECHb, TRAN, TRAN_N, RST, SET, PBSENSE, and PBYPASS described hereinafter may be output from the control circuit 120. The page buffers PB0˜PBk have the same configuration, so the page buffer PB0 will be described as an example hereinafter.

The page buffer PB0 includes a bit line connection circuit N101, a precharge circuit P101, a latch circuit LC, and a data input/output circuit PBIO. In FIG. 3, a case in which the page buffer includes a single latch circuit is described as an example, but the page buffer may include a plurality of latch circuits.

In response to a connection signal PBSENSE<0>, the bit line connection circuit N101 performs an operation of connecting a bit line and the latch circuit LC. The latch circuit LC is connected to the bit line connection circuit N101, and a connection node of the bit line connection circuit N101 and the latch circuit LC is a sensing node SO. In response to the precharge signal PBSENSE<0>, the precharge circuit P101 performs an operation of precharging the sensing node SO.

The latch circuit LC may temporarily store data input from the column selecting circuit (160 in FIG. 1), or may temporarily store data read from a memory cell according to a read operation in order to output the data to the column selecting circuit 160. During a program operation, the latch circuit LC may perform an operation of applying a program inhibition voltage or a program permission voltage to a bit line. Also, the latch circuit LC may perform an operation of temporarily storing data stored in a memory cell in response to a voltage of the bit line during the read operation.

The latch circuit LC includes a plurality of switching elements and a latch. The latch circuit LC includes a latch LAT for latching data, a switching element N102 configured to connect a first node QA[0] of the latch LAT to the sensing node SO[0] in response to a transmission signal TRAN<0>, a switching element N103 configured to connect a second node QB[0 of the latch LAT to the sensing node SO[0] in response to a reverse transmission signal TRAN_N<0>, switching elements N104 and N105 connected to the first node (non-inverting terminal, QA[0]) and the second node (inverting terminal, QB[0]) of the latch LAT, and operating in response to a set signal SET<0> and a reset signal RST<0>, respectively, and a switching element N106 connected between the switching elements N104 and N105 and a ground terminal, and operating according to the potential of the sensing node SO[0].

The data input/output circuit PBIO includes a switching element N107 configured to connect the first node QA[0] of the latch LAT to a data input/output terminal PBBITOUT in response to a data input/output signal PBYPASS<0>, and a switching element N108 configured to connect the second node QB[0] of the latch LAT to an inverting data input/output terminal PBBITOUTb in response to a data input/output signal PBYPASS<0>. The data input/output signal PBYPASS<0> is input when a page buffer is selected by the column selecting circuit (160 in FIG. 1). In an embodiment in accordance with the present invention, even numbered page buffers (referred to as ‘even page buffers’, hereinafter), among the entire page buffers, are sequentially selected by the column selecting circuit 160, and thereafter, odd numbered page buffers (referred to as ‘odd page buffers’, hereinafter) are sequentially selected. Accordingly, data input signals are input to respective page buffers.

In order for the column selecting circuit 160 to sequentially select the even page buffers, and subsequently select the odd page buffers, the column address counter 180 increases the column address by two each time. This will be described in detail subsequently.

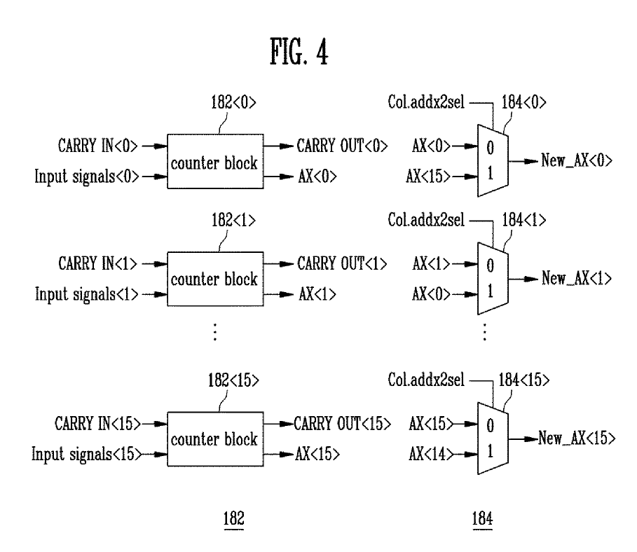

FIG. 4 is a circuit diagram illustrating the column address counter illustrated in FIG. 1. Referring to FIG. 4, the column address counter includes a counter block group 182 and a multiplexer group 184. The counter block group 182 includes a plurality of unit counter blocks 182<0>˜182<15>, and the multiplexer group 184 includes a plurality of multiplexers 184<0>˜184<15>. A case in which one page is comprised of 16 bits will be described as an example.

The counter block 182<0> receives an input signal Input signal<0> and a carry input signal CARRYIN<0> and outputs a column address signal (AX<0> and a carry output signal CARRYOUT<0>,

The multiplexer 184<0> outputs a column address signal AX<0> or a column address signal AX<15> as a new column address signal New_AX<0> in response to a column address selection signal Col.add x2 sel.

In this manner, the column address counter includes a plurality of multiplexers 184<0>˜184<15> and increases the column address by ‘2’ each time (e.g., 0→2→4→ . . . →12-→14→1→3→ . . . →13→15), in comparison to the related art in which the column address is increased by ‘1’ each time (e.g., 0→1→2→ . . . →14→15). Specifically, when a column address selection signal Col.add x2 sel is input as ‘1’, the multiplexers 184<0>˜184<15> shift the column address signals AX<15:0> by 1 bit to output new column address signals New_AX<15:0> to allow the column address to be increased by ‘2’ each time.

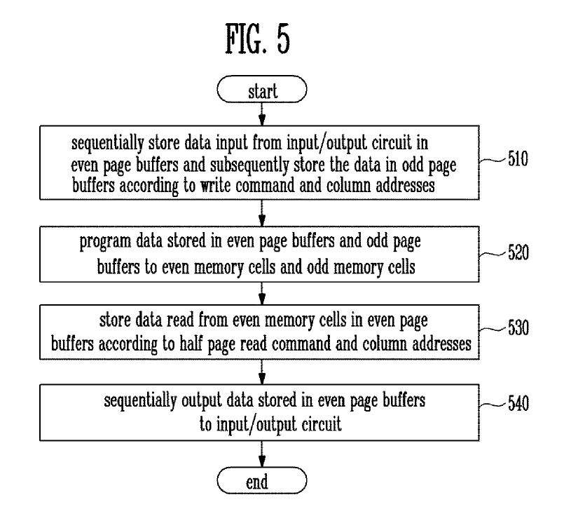

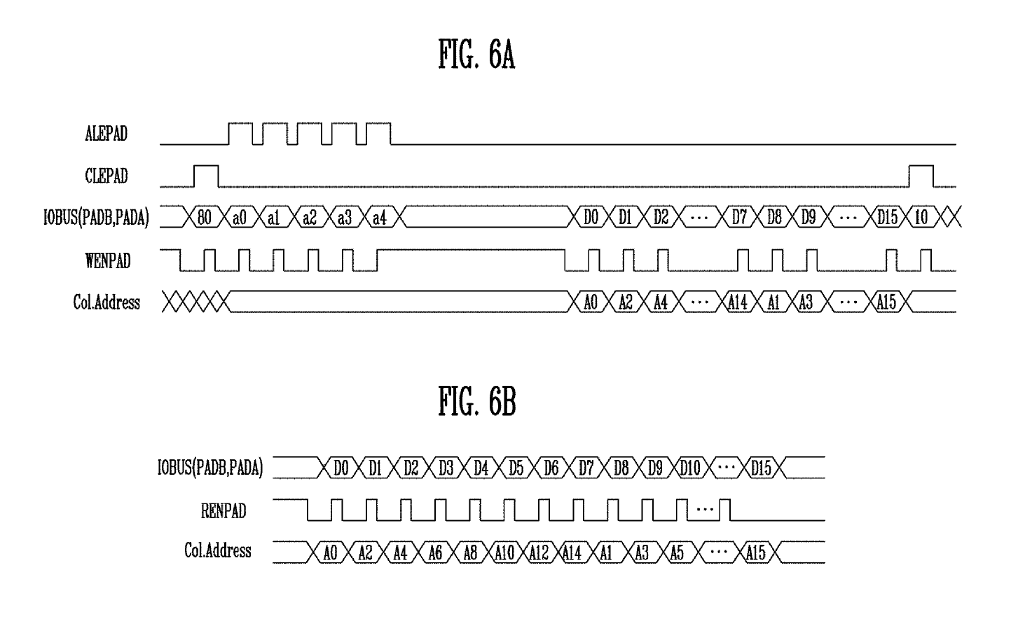

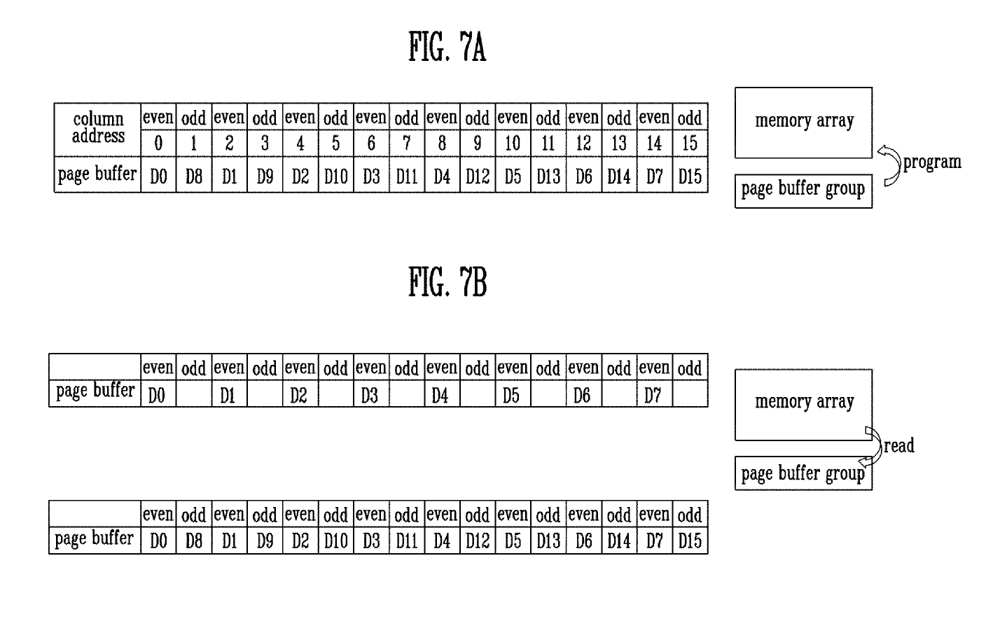

FIG. 5 is a flow chart illustrating an operating method of a semiconductor memory device according to an embodiment of the present invention. FIGS. 6A and 6B are timing diagram illustrating an operating method of a memory device. FIGS. 7A and 7B are conceptual views illustrating an operating method of the semiconductor memory device according to an embodiment of the present invention. An operating method of a semiconductor memory device in accordance with an embodiment of the present invention is applied when data is read by voltage sensing in a semiconductor memory device in which one page buffer corresponds to one bit line (All Bit Line (ABL)). In particular, an operating method in accordance with the present invention is applied to the case in which one page corresponds to one word line. In this case, a read operation may be performed only on the entirety of one page. However, when a user wants to read data of a half page or smaller, since the number of memory cells from which data is to be read is one-half page or less, there is no need to perform a read operation on every memory cell. In this case, data may be read from even numbered memory cells only (referred to as ‘even memory cells’, hereinafter) or odd numbered memory cells only (referred to as ‘odd memory cells’, hereinafter) to reduce the time required for the read operation. Here, the order of data input from the column selecting circuit (160 in FIG. 1) to the page buffers is changed, such that the order of input data itself is not changed, although the input data is read only from the even memory cells or the odd memory cells.

First, an operation of programming data input from an input/output circuit to memory cells will be described. Referring to FIG. 6, when a command ‘80’ (data write command) is input from an input/output circuit of the semiconductor memory device, a control circuit outputs a command enable signal CLE. Thereafter, when an address is input from the input/output circuit according to a write enable signal WE#, the control circuit outputs an address enable signal ALE and a start column address AO is determined. When a column address counter receives a start column address A0 from the control circuit, it increases a column address by ‘2’ each time and outputs the new column address. This is to change the order of inputting data to the page buffers. Column addresses are output in order of A0, A2, A4, . . . , to a column selecting circuit. Thereafter, data D0˜D15 is input from the input/output circuit according to a write enable signal WE#. The column selecting circuit selects a page buffer according to a column address and stores data in each page buffer. When a command ‘10’ is input from the input/output circuit of the semiconductor memory device, the control circuit outputs a command enable signal CLE. Accordingly, the operation is terminated. As described above, in accordance with an embodiment of the present invention, since the column addresses A0, A2, A4, . . . , increased by ‘w’ each time by the column address counter, are input to the column selecting circuit, first data D0˜D7 are input to the even page buffers and subsequently second data D8˜D15 are stored in the odd page buffers (step 510).

In the general ABL type semiconductor device, when data is input from the input/output circuit, page buffers are selected (by the column selecting circuit) according to column addresses to sequentially provide data to each page buffer. For example, when one page stores 16-bit data, the entire data D0˜D15 are sequentially stored in each data buffer according to column addresses. However, in accordance with an embodiment of the present invention, after the first data D0˜D7 are sequentially stored in the even page buffers, the second data D8˜D15 are sequentially stored in the odd page buffers. This will be described in more detail below.

Referring to FIG. 7A, when a column address ‘0’ is input, the column selecting circuit selects a first even page buffer. Accordingly, data D0 is stored to the even page buffer. The column address is increased by ‘2’ by the column address counter and the column selecting circuit selects the next even page buffer, rather than an odd page buffer. Accordingly, data D1 is stored. These steps are repeatedly performed and data D7 is stored in the last even page buffer. Thereafter, when the column address is increased by ‘2’ by the column address counter, since the column address exceeds the size of the entire page, the column address counter outputs a carry signal CARRY as described above with reference to FIG. 4. Accordingly, the column selecting circuit selects the first even page again. Here, when the carry signal CARRY is added to the column address ‘0’, the column selecting circuit selects a first odd page buffer. Accordingly, data D8 is stored in the first odd page buffer. Since the column address is increased by ‘2’ each time by the column address counter, data D9˜D15 are sequentially stored in the odd page buffer. As a result, input data D0˜D15 are stored in order of D0, D8, D1, D9, D2, D10, D3, D11, D4, D12, D5, D13, D6, D14, D7, D15. In accordance with an embodiment of the present invention, the input data are sequentially stored in the even page buffers, and subsequently stored in the odd page buffers. Meanwhile, when the size of input data is a half page or smaller, the input data may be stored only in the even page buffers (or only in the odd page buffers).

When data input to the even page buffers and odd page buffers is completed, the data stored in the even page buffers and the odd page buffers are programmed to memory cells (step 520). Here, the data stored in the even page buffers are programmed to even memory cells among memory cells, and the data stored in the odd page buffers are programmed to odd memory cells among the memory cells. Programming may be simultaneously performed on the even memory cells and the odd memory cells.

Hereinafter, an operation of reading data stored in memory cells and outputting the same to the input/output circuit will be described. In the ABL type data read operation, data are simultaneously read from memory cells of one page and stored in each page buffer. In accordance with an embodiment of the present invention, although the ABL type data read operation is employed, an operation of outputting data read from even memory cells through even page buffers, and an operation of storing data read from odd memory cells to odd page buffers, may be separately performed by using a half page read command. For example, data read from even memory cells according to a half page read command and column addresses is stored in even page buffers (step 530). To this end, the control circuit may separately output page buffer signals (PBSIGNALS in FIG. 1) to even page buffers and odd page buffers.

Referring to FIG. 7B, when a half page read command is input from an external (user) input/output circuit, only one of the data D0˜D7 stored in the even memory cells, or data D8˜D15 stored in the odd memory cells, is output. When a full page read command is input from the external (user) input/output circuit, the data D0˜D7 stored in the even memory cells may be output and the data D8˜D15 stored in the odd memory cells may be subsequently output. In other words, when the full page read command is input, the first data D0˜D7 stored in the even memory cells are stored to the even page buffers through a first read operation, and the second data D8˜D15 stored in the odd memory cells are stored to the odd page buffers through a second read operation. Alternatively, sequentially read data may be stored to the even page buffers and the odd page buffers.

As for the data D0˜D15 stored in the page buffers, the order in which data was stored in each page buffer was changed when the data was input from the input/output circuit to each page buffer, so data output order should be changed when data D0˜D15 are output to the input/output circuit. In particular, when data are output, the column selecting circuit sequentially selects even page buffers according to column addresses to output the first data D0˜D7, and thereafter, the column selecting circuit selects odd page buffers to output the second data D8˜D15.

Referring to FIG. 6B, when a full page read command is input, in order for the column selecting circuit to sequentially select even page buffers according to column addresses to output the first data D0˜D7, and subsequently select odd page buffers to output the second data D8˜D15, the column address counter increases the column address by ‘2’ each time, from the start column address A0, and outputs the same whenever a read enable signal RE# is toggled once. Accordingly, when the data D0˜D15 is output to an external device by the input/output circuit, the data D0˜D15 may be output to the external device in the same order in which the original data D0˜D15 were input by the input/output circuit.

When a half page read command is input, the column selecting circuit sequentially selects even page buffers according to column addresses to output the first data D0˜D7, or selects odd page buffers to output the second data D8˜D15, in data outputting (step 540). Whenever the read enable signal RE# is toggled once, the column address counter increases the column address by ‘2’ each time, starting from the start column address A0, and outputs the same. Thus, when the user wants to read data having a size of a half page or smaller, the read operation is performed only on a half page through a half page read command, thus reducing a time required for the data read operation.

As described in detail above, in accordance with an embodiment of the present invention, when input data is latched to page buffers: first, the data is sequentially latched to even page buffers and subsequently latched to odd page buffers; and then, the data is programmed to each memory cell. Thus, when data having a size of a half page or smaller is read, a read operation is performed only on even memory cells or odd memory cells, thus reducing a time required for the read operation.

While the present invention has been shown and described in connection with the embodiments, it will be apparent to those skilled in the art that modifications and variations can be made without departing from the spirit and scope of the invention as defined by the appended claims.

What is claimed is:

1. A semiconductor memory device comprising:
a memory block including memory cells electrically connected to bit lines;
a page buffer group including page buffers disposed to correspond to the bit lines in a one-to-one manner and divided into even page buffers and odd page buffers; and
a control circuit configured to control the page group to sequentially store data in even memory cells among the memory cells through the even page buffers and subsequently store data in odd memory cells through the odd page buffers in response to a write command, and sequentially output data read from the even memory cells through the even page buffers in response to a half page read command.

2. The semiconductor memory device of claim 1, wherein the control circuit controls the page buffer group to sequentially output the data read from the odd memory cells through the odd page buffers in response to the half page read command.

3. The semiconductor memory device of claim 1, wherein, when a full page read command is input, the control circuit controls the page buffer group to sequentially output the data read from the even memory cells through the even page buffers and subsequently sequentially output the data read from the odd memory cells through the odd page buffers, in response to the full page read command.

4. A semiconductor memory device comprising:
a memory block including memory cells electrically connected to bit lines;
a page buffer group including page buffers disposed to correspond to the bit lines in a one-to-one manner and divided into even page buffers and odd page buffers;
a column selecting circuit configured to select either the even page buffers or the odd page buffers according to column addresses to perform a data input/output operation on even memory cells among the memory cells through the even page buffers, and perform a data input/output operation on odd memory cells through the odd page buffers; and
a column address control circuit configured to output the column addresses to allow the column selecting circuit to sequentially select the even page buffers and subsequently select the odd page buffers during a data input operation in response to a write command, and output the column addresses to allow the column selecting circuit to sequentially select the even page buffers during a data output operation in response to a half page read command.

5. The semiconductor memory device of claim 4, wherein the column address control circuit outputs the column addresses to allow the column selecting circuit to sequentially select the odd page buffers during a data output operation in response to the half page read command.

6. The semiconductor memory device of claim 4, wherein the column address control circuit outputs the column addresses by increasing the column address by ‘2’ each time, starting from a start column address.

7. The semiconductor memory device of claim 4, wherein, when a full page read command is input, the column address control circuit outputs the column addresses to allow the column selecting circuit to sequentially select the even page buffers and subsequently sequentially select the odd page buffers during a data output operation, in response to the full page read command.

8. A method for operating a semiconductor memory device in which page buffers are disposed to correspond to bit lines in a one-to-one manner, the method comprising the steps of:
sequentially storing data input from an input/output circuit in even memory cells and subsequently storing the data in odd memory cells according to a write command and column addresses; and
outputting data read from the even memory cells to the input/output circuit according to a half page read command and column addresses.

9. The method of claim 8, wherein the step of sequentially storing data further comprises the steps of:
sequentially storing the data input from the input/output circuit in even page buffers and subsequently storing the data in the odd page buffers according to the write command and column addresses; and
programming data stored in the even page buffers and the odd page buffers to the even memory cells and the odd memory cells.

10. The method of claim 8, wherein the step of outputting data further comprises the steps of:
storing the data read from the even memory cells in the even page buffers according to the half page read command and column addresses; and
sequentially outputting the data stored in the even page buffers to the input/output circuit.

11. The method of claim 8, wherein, in outputting data, the data read from the odd memory cells is output to the input/output circuit according to the half page read command and column addresses.

12. The method of claim 11, wherein the step of outputting data further comprises:
storing the data read from the odd memory cells in the odd page buffers according to the half page read command and column addresses; and
sequentially outputting the data stored in the odd page buffers to the input/output circuit.

13. The method of claim 8, wherein step of outputting data further comprises:
when a full page read command is input, outputting the data read from the even memory cells to the input/output circuit and subsequently outputting the data read from the odd memory cells to the input/output circuit according to the full page read command and the column addresses.

14. The operating method of claim 8, wherein the column address is increased by ‘2’ each time, starting from a start column address.

15. An method for operating a semiconductor memory device in which page buffers are disposed to correspond to bit lines in a one-to-one manner, the method comprising the steps of:
sequentially storing data input from an input/output circuit in even memory buffers according to a write command and column addresses;
programming the data in even memory cells;
reading the data programmed in the even memory cells to the even page buffers; and
sequentially outputting the data stored in the even page buffers to the input/output circuit according to a half page read command and column addresses.

16. The method of claim 15, wherein, in the storing and outputting of data, the column address is increased by ‘2’ each time, starting from a start column address.
